(19) United States
(12) Patent Application Publication
(10) Pub. No.: US 2025/0338786 A1
(43) Pub. Date: Nov. 6, 2025

(54) SOIL TREATMENT APPARATUS

(71) Applicant: NOVOKRAFT AG, Riehen (CH)

(72) Inventors: Eric Hardman, Riehen (CH); Rob Jansen, Bergeijk (NL)

(21) Appl. No.: 19/269,711

(22) Filed: Jul. 15, 2025

Related U.S. Application Data
(63) Continuation of application No. PCT/EP2024/050420, filed on Jan. 10, 2024.

(30) Foreign Application Priority Data
Jan. 16, 2023 (DE) 10 2023 100 914.1

(51) Int. Cl. A01B 49/04; A01B 45/02

(52) U.S. Cl. CPC A01B 49/04; A01B 45/023

(57) ABSTRACT

A soil treatment apparatus for loosening soil includes a supporting device and a holding device movably held on the supporting device. A plurality of injection elements are held on the holding device. The injection elements are insertable into and withdrawable from soil via a lifting device. A fluid supply device is in fluid connection with the injection elements for providing fluid. The supporting device includes a first supporting device portion and a second supporting device portion. The soil treatment apparatus is configured to be caused to move in a processing direction via the first supporting device portion. The holding device is held on the second supporting device portion. The first and second supporting device portions are arranged one behind the other in the processing direction and interconnected so as to be movable and in particular displaceable relative to one another in the processing direction.

### CROSS-REFERENCE TO RELATED APPLICATIONS

This application is a continuation application of international application number PCT/EP2024/050420, filed on Jan. 10, 2024, and claims the benefit of German application number 10 2023 100 914.1, filed on Jan. 16, 2023, which are incorporated herein by reference in their entireties and for all purposes.

### FIELD

The present disclosure relates to a soil treatment apparatus for loosening soil.

In particular, the present disclosure relates to a soil treatment apparatus for loosening soil in soils with grass growth.

### BACKGROUND

A generic soil treatment apparatus is described, for example, in DE 10 2018 122 086 A1 and is used to manage soil, for example using needle-shaped injection elements to inject a fluid into the soil. Under the action of the fluid, in particular compressed gas or compressed gas mixture, especially compressed air (in this case the term aeration is used), loosening and thus better ventilation and dewatering of the soil is achieved. Air and water can penetrate the soil better and the drainage effect is improved. In soils with grass growth, for example in sports or leisure facilities, the root system can spread better in the earth to promote growth.

Further soil treatment apparatus for fluid injection and in particular for aeration are described in DE 10 2016 105 248 A1, DE 10 2015 115 991 A1 and DE 10 2016 105 253 A1.

Such soil treatment apparatus generally have a voluminous basic structure in order to be able to accommodate, for example, a relative movement mechanism by means of which, for example, the injection elements for injecting the fluid can be introduced into the soil during driving operation of the soil treatment apparatus.

Furthermore, these soil treatment apparatus usually require complex control of this relative movement mechanism in order, for example, to compensate for movement of the driving operation of the soil treatment apparatus during the injection of the fluid, in particular to avoid possible damage to the injection elements, for example with regard to bending of the injection elements.

### SUMMARY

Therefore, an object underlying the present disclosure is to provide such a soil treatment apparatus, in particular having a simpler and/or more compact design.

In an aspect of the present disclosure, a soil treatment apparatus for loosening the soil is provided, in particular in soils with grass growth.

Accordingly, it is provided that a soil treatment apparatus for loosening soil, in particular in soils with grass growth, comprises a supporting device and a holding device movably held thereon, on which a plurality of injection elements are held, a lifting device via which the injection elements are insertable into and withdrawable from the soil, and a fluid supply device which is directly or indirectly in fluid connection with the injection elements for providing fluid. The supporting device comprises at least a first and a second supporting device portion, wherein the soil treatment apparatus is configured to be caused to move in a processing direction via the first supporting device portion and the holding device is held on the second supporting device portion. The first and the second supporting device portion are arranged one behind the other in the processing direction and are interconnected so as to be movable and in particular displaceable relative to one another in the processing direction.

### BRIEF DESCRIPTION OF THE DRAWINGS

The foregoing summary and the following description may be better understood in conjunction with the drawing figures, of which:

FIG. 1 is a perspective view of a soil treatment apparatus in accordance with an exemplary embodiment of the present disclosure with a user;

FIG. 2 is another perspective view of the soil treatment apparatus of FIG. 1;

FIG. 3 is a plan view of the soil treatment apparatus from FIG. 1;

FIG. 4 is a sectional detail view A along the section line A-A of FIG. 3;

FIG. 5 is a sectional detail view B along the section line B-B of FIG. 3;

FIG. 6 is a side detail view C of FIG. 2;

FIG. 7 is a side view of the soil treatment apparatus of FIG. 1 in a soil treatment position and/or in a pushed-together state;

FIG. 8 is a side view of the soil treatment apparatus of FIG. 1 in a transport position and/or in a pushed-together state;

FIG. 9 is a side view of the soil treatment apparatus of FIG. 1 in a soil treatment position and/or in a pulled-out state;

FIG. 10 is a perspective view of a soil treatment apparatus in accordance with a further exemplary embodiment of the present disclosure;

FIG. 11 is a side view of the soil treatment apparatus of FIG. 10 in a soil treatment position and/or in a pushed-together state;

FIG. 12 is a plan view of the soil treatment apparatus of FIG. 10;

FIG. 13 is a side view of a soil treatment apparatus in accordance with a further exemplary embodiment of the present disclosure in a transport position and/or in a pushed-together state; and

FIG. 14 is a side view of a soil treatment apparatus in accordance with a further exemplary embodiment of the present disclosure in a transport position and/or in a pushed-together state.

### DETAILED DESCRIPTION

Although the present disclosure is illustrated and described herein with reference to specific embodiments, the present disclosure is not intended to be limited to the details shown. Rather, various modifications may be made in the details within the scope and range of equivalents without departing from the present disclosure.

The present disclosure relates to a soil treatment apparatus for loosening soil, in particular in soils with grass growth, comprising a supporting device and a holding device movably held thereon, on which a plurality of injection elements are held, a lifting device via which the injection elements are insertable into and withdrawable from the soil, and a fluid supply device which is directly or indirectly in fluid connection with the injection elements for providing fluid, wherein the supporting device comprises at least a first supporting device portion and a second supporting device portion, wherein the soil treatment apparatus is configured to be caused to move in a processing direction via the first supporting device portion and the holding device is held on the second supporting device portion, wherein the first supporting device portion and the second supporting device portion are arranged one behind the other in the processing direction and are interconnected so as to be movable and in particular displaceable relative to one another in the processing direction.

In this way, in particular, a soil treatment apparatus can be provided in which a deceleration can be generated between the first and the second supporting device portion during driving operation, due to the mobility of the first and the second supporting device portion relative to one another, so that injection elements associated with the second supporting device portion can be inserted into and withdrawn from the soil during the driving operation. In particular, the soil treatment apparatus in accordance with the present disclosure can have a simple and/or compact design, since in this case, for example, a separate relative movement mechanism for controlled movement alignment between the moving soil treatment apparatus and the holding device and/or the injection elements is advantageously not required and can be dispensed with. The soil treatment apparatus can thus be free of an in particular separate relative movement mechanism, in particular for the controlled movement alignment between the moving soil treatment apparatus and the holding device and/or the injection elements, and/or preferably does not comprise such a mechanism.

It should be understood that orientation and position information refers in particular to the intended use of the soil treatment apparatus, which is or can be moved in a processing direction on the soil surface. For example, a transverse direction can be oriented transversely and in particular perpendicularly to the processing direction. In particular, for the purposes of the present description, it is assumed that the soil surface is oriented substantially horizontally and a contact plane of the soil treatment apparatus substantially coincides with the plane defined by the soil surface.

The lowering of the injection elements for insertion into the soil and the lifting for withdrawal from the soil can be carried out, for example, via the holding device in the manner described in one of the documents mentioned at the outset. Alternatively, for example, a solution can be used as described in the not previously published patent application DE 10 2023 100 886.2 of the same applicant with the same filing date as the present patent application. “Insertion” can, for example, comprise a solution in which the injection elements are driven into the soil under the action of a fluid. “Withdrawal” can, for example, comprise a solution in which the injection elements are removed under the action of a fluid and/or an elastic restoring device.

It can be provided that the injection elements are insertable into and withdrawable from the soil by means of the lifting device during a relative movement and in particular a relative displacement of the first supporting device portion and the second supporting device portion to one another or when the soil treatment apparatus is not caused to move. This preferably ensures that damage to the injection elements when inserted into the soil, when arranged in the soil and/or when withdrawn, for example as a result of a shear force caused by movement, can be reliably avoided.

It can be provided that one or more or all injection elements are held on the holding device so as to be movable relative to the holding device and that the lifting device comprises at least a number of lifting elements corresponding to the injection elements held so as to be movable on the holding device, via which lifting elements the respective injection elements are insertable into and withdrawable from the soil, in particular singly and/or individually insertable and withdrawable.

For example, a respective lifting element can be operatively connected to a respective injection element for insertion into and withdrawal from the soil. In particular, the lifting elements can be fixed to the holding device.

It can be provided that the lifting device, in particular the lifting elements of the lifting device, is in direct or indirect fluid connection with the fluid supply device.

It can be provided that the soil treatment apparatus comprises an adjustment device by means of which the holding device can be lifted and lowered relative to the soil. In particular, the adjustment device can be mechanical or electrical. For example, the adjustment device can be in the form of an electrical adjustment unit, in particular an electrical linear actuator. The adjustment device can, for example, serve to adjust a distance of the holding device with respect to the soil and/or can, for example, enable a soil treatment position of the holding device, in which the holding device is lowered, and a transport position of the holding device, in which the holding device is lifted.

Additionally or alternatively, it can be provided that one or more or all injection elements are rigidly held on the holding device and the lifting device comprises at least one further lifting element, for example a main lifting element, via which the holding device can be lifted and lowered relative to the soil, and the respective injection elements rigidly held on the holding device can thereby be inserted into and withdrawn from the soil.

In particular, the at least one further lifting element can be fixed to the second supporting device portion and the holding device and can interconnect the second supporting device portion and the holding device.

It can be provided that the further lifting element of the lifting device is in direct or indirect fluid connection with the fluid supply device.

It can be provided that the first supporting device portion and the second supporting device portion are at least partly mounted in and/or on one another in order to be movably and in particular displaceably interconnected. This makes it possible, for example, to realize a particularly compact design of the supporting device and thus of the soil treatment apparatus.

It can be provided that at least one part of the first supporting device portion or the second supporting device portion is in the form of a first guide element and at least one part of the other supporting device portion is in the form of a second guide element, wherein the first guide element and the second guide element are displaceably connected and in particular telescopically interconnected. This makes it possible, for example, to realize a particularly simple and at the same time compact design of the supporting device portions and thus of the soil treatment apparatus.

It can be provided that the supporting device comprises at least one bearing arrangement, preferably at least one plain bearing arrangement, rolling element arrangement or roller bearing arrangement, which is provided between the first supporting device portion and the second supporting device portion, in particular between the first guide element and the second guide element. As a result, a smooth relative movement and in particular relative displacement between the first guide element and the second guide element and thus between the first and the second supporting device portion can be realized, for example in which a reduced frictional resistance and/or rolling resistance occurs. In particular, the supporting device can be based on the concept of using at least one bearing arrangement for displaceably guiding the first and the second supporting device portion, which arrangement enables a particularly precise and smooth guidance of the supporting device portions relative to one another.

It can be provided that the at least one bearing arrangement is in the form of a roller bearing arrangement which comprises at least one roller. The at least one roller can be fixed to the first supporting device portion or the second supporting device portion, in particular to the first guide element or the second guide element, and can be arranged between the first supporting device portion and the second supporting device portion, in particular between the first guide element and the second guide element.

Alternatively, it can be provided that the at least one bearing arrangement is in the form of a rolling element body which comprises at least one rolling body cage and a plurality of rolling bodies. The rolling body cage can be arranged on and/or at the respective rolling bodies between the first supporting device portion and the second supporting device portion, in particular between the first guide element and the second guide element. A rolling body can be in the form of a ball, for example. It should be understood that any rolling body configuration suitable for the present purpose is alternatively conceivable.

It should be understood that the present bearing arrangement is not limited to a rolling body arrangement or a roller bearing arrangement, but rather may be in the form of any means suitable for displaceably guiding the first and the second supporting device portion relative to one another. It is conceivable here, for example, for the at least one bearing arrangement to have at least one means for sliding, in particular at least one plain bearing arrangement, for said purpose or to be in the form of such an arrangement.

It can be provided that the first supporting device portion and the second supporting device portion are movable and in particular displaceable between a first relative position and a second relative position relative to one another in the processing direction, wherein, when the first supporting device portion and the second supporting device portion are in the first relative position, the supporting device has a shortest extent in the processing direction and, when the first supporting device portion and the second supporting device portion are in the second relative position, the supporting device has a longest extent in the processing direction.

This can be understood in particular to mean that when the first supporting device portion and the second supporting device portion are in the first relative position, the soil treatment apparatus assumes a pushed-together state and, when the first supporting device portion and the second supporting device portion are in the second relative position, the soil treatment apparatus assumes a pulled-out state.

For example, a switching process from the first relative position to the second relative position and/or from the pushed-together state to the pulled-out state can be understood to mean extending and/or pulling apart.

For example, a switching process from the second relative position to the first relative position and/or from the pulled-out state to the pushed-together state can be understood to mean shortening and/or contracting.

For example, it can be provided that the injection elements are insertable into and withdrawable from the soil by means of the lifting device, in particular by means of the lifting elements of the lifting device, during the extension and/or pulling apart.

In particular, it can be provided that when the injection elements are inserted into the soil, the fluid can be supplied to the soil via the injection elements, in particular can be injected into the soil.

In particular, it can be provided that after the supporting device has been extended and/or pulled apart, in particular each time it is extended or pulled apart, shortening and/or contracting of the supporting device can be initiated.

It can be provided that the soil treatment apparatus comprises at least one braking device, by means of which the second supporting device portion is configured to be slowed down and/or braked relative to the first supporting device portion, in particular with respect to a movement in the processing direction. This can in particular serve for and/or result in the supporting device being extendable in the processing direction when the soil treatment apparatus is moved in the processing direction. This provides a simple solution, in particular without additional relative movement mechanisms, for braking the second supporting device portion during the driving operation of the soil treatment apparatus to such an extent as to allow the injection elements to be inserted into and withdrawn from the soil during the ongoing driving operation of the soil treatment apparatus.

This can be understood in particular to mean that by means of the at least one braking device, the supporting device can be caused to extend and/or pull apart when the soil treatment apparatus moves in the processing direction, in particular when the soil treatment apparatus is caused to move in the processing direction.

Braking can in particular lead to a temporary standstill of the second supporting device portion relative to the soil.

For example, the first supporting device portion and the second supporting device portion can be transferred from the first relative position to the second relative position and/or the supporting device can be transferred from the pushed-together state to the pulled-out state via the at least one braking device when the first supporting device portion is moved further in the processing direction.

It can be provided that the second supporting device portion comprises at least one support element for resting on the soil, via which element the soil treatment apparatus and in particular the supporting device of the soil treatment apparatus is guidable and in particular drivable over the soil, wherein the at least one braking device for slowing down and/or braking the second supporting device portion is configured to be brought into engagement with the at least one support element and/or directly with the soil.

Since this at least one support element is provided on the second supporting device portion, this at least one support element can be regarded and/or referred to as, for example, a rear support element.

It can be provided that the at least one support element, in particular the rear one, is in the form of a wheel or a roller. However, it should be understood that the at least one support element, in particular the rear one, can be configured differently, for example as a runner, continuous track and/or creeper belt.

It can be provided that the at least one support element, in particular the rear one, is in the form of a steered or unsteered support element.

It can be provided that the at least one braking device is directly or indirectly in fluid connection with the fluid supply device and is fluidically actuatable for slowing down and/or braking the second supporting device portion.

It can be provided that by means of the at least one braking device, the second supporting device portion is configured to be slowed down relative to the first supporting device portion via a frictional connection and/or braked via a frictional connection and/or via a positive engagement.

For example, it can be provided that the at least one braking device for slowing down and/or braking the second supporting device portion can be brought into frictional and/or positive engagement with the at least one support element, in particular the rear support element, and/or directly with the soil.

For example, it can be provided that at least one support element, in particular rear support element, in the form of a wheel or a roller is provided on the second supporting device portion, and the at least one braking device comprises a braking element, which is provided with a brake pad, and a fluidically actuatable actuator, the brake pad being pressable against this support element by a movement of the braking element able to be brought about by means of the actuator.

The at least one actuator can, for example, be fixed with a first end to the second supporting device portion, the braking element being arranged at a second end facing away from the first end.

It can be provided that the soil treatment apparatus comprises at least one return device which is fixed to the first supporting device portion and the second supporting device portion and interconnects the first supporting device portion and the second supporting device portion, the first supporting device portion and the second supporting device portion being movable relative to one another and in particular toward one another by means of the at least one return device. This makes it possible, for example, to allow quasi-continuous or continuous operation of the soil treatment apparatus, since the first and the second supporting device portion can be moved apart from and toward one another as required and the injection elements are insertable into and withdrawable from the soil in a correspondingly coordinated manner.

This can be understood in particular to mean that, by means of the at least one return device, the supporting device can be caused to shorten and/or contract and/or the shortening and/or contraction of the supporting device can be brought about, advantageously while the soil treatment apparatus moves in the processing direction, in particular while the soil treatment apparatus is caused to move in the processing direction.

For example, the first supporting device portion and the second supporting device portion can be transferred from the second relative position to the first relative position and/or the supporting device can be transferred from the pulled-out state to the pushed-together state by means of the at least one return device.

It can be provided that the at least one return device is in direct or indirect fluid connection with the fluid supply device.

It should be understood that the at least one braking device is advantageously released and/or unactuated during shortening and/or contraction.

It can be provided that the at least one return device and the at least one braking device are operatively interconnected, in particular are fluidically operatively interconnected.

For example, actuation of the at least one return device for shortening and/or contracting the supporting device, for example applying pressure to the at least one return device, can be coupled with release and/or non-actuation of the at least one braking device, for example with switching the at least one braking device to a pressureless state.

Furthermore, for example, actuation of the at least one return device for extending and/or pulling apart the supporting device, for example switching the at least one return device to a pressureless state, can be coupled with engagement and/or actuation of the at least one braking device, for example applying pressure to the at least one braking device.

It can be provided that the soil treatment apparatus has at least one guide apparatus, by means of which the holding device is movably held on the supporting device, in particular the second supporting device portion, and via which the holding device is liftable and lowerable, in particular by means of the adjustment device and/or the lifting device, for example the further lifting element of the lifting device.

It can be provided that the at least one guide apparatus comprises or forms at least one joint apparatus or at least one linear guide apparatus for translational guidance.

It can be provided that the at least one guide apparatus comprises at least a first guide member and a second guide member, which are each mounted on the holding device and on the supporting device and which are arranged spaced apart from one another and substantially parallel to one another.

It can be provided that a parallelogram linkage for lifting and lowering the holding device is realized by means of the first guide member and the second guide member.

It can be provided that the adjustment device is mounted on the inside of the second supporting device portion and/or the holding device with respect to an extent of the second supporting device portion and/or the holding device oriented transversely and in particular perpendicularly to the processing direction and interconnects the second supporting device portion and the holding device.

It can be provided that the soil treatment apparatus has at least one travel drive, in particular at least one motor, which is arranged on and/or in the first supporting device portion and by means of which the soil treatment apparatus is configured to be caused to move in the processing direction.

It can be provided that at least one support element for resting on the soil is provided on the first supporting device portion, via which element the soil treatment apparatus and in particular the supporting device of the soil treatment apparatus is guidable and in particular drivable over the soil, wherein the at least one support element can be driven by means of the at least one travel drive.

Since this at least one support element is provided on the first supporting device portion, this at least one support element can be regarded and/or referred to as a front support element.

It can be provided that the at least one support element, in particular the front one, is in the form of a wheel or a roller. However, it should be understood that the at least one support element, in particular the front one, can be configured in an alternative way, for example as a continuous track and/or creeper belt.

It can be provided that the at least one support element, in particular the front one, is in the form of a steered or unsteered support element.

Additionally or alternatively, it can be provided that the soil treatment apparatus has at least one coupling device which is arranged on and/or in the first supporting device portion for coupling the soil treatment apparatus to a separate drive system, in particular a towing vehicle, and via which the soil treatment apparatus is configured to be caused to move in the processing direction, in particular by means of a tensile force able to be exerted by the separate drive system.

It can be provided that the soil treatment apparatus has a steering apparatus via which the processing direction is variable, wherein the steering apparatus is manually actuatable by a user and/or by a separate drive system, in particular a towing vehicle, in particular by means of a pulling movement able to be generated thereby and/or actuatable and in particular controllable automatically by means of a control unit associated with the soil treatment apparatus or comprised by the soil treatment apparatus, preferably self-drivingly and/or self-steeringly controllable.

For example, it can be provided that the at least one in particular front support element on the first supporting device portion and/or the at least one in particular rear support element on the second supporting device portion can be steered by means of the steering apparatus.

For example, it can be provided that the steering apparatus comprises a motor, in particular an electric motor, via which the processing direction can be varied.

It can be provided that there is movably held on the supporting device at least one roller-shaped support device which is arranged upstream and/or downstream of the injection elements with respect to the processing direction and extends transversely and in particular perpendicularly to the processing direction.

For example, the roller-shaped support device can be held movably on the second supporting device portion and advantageously on the holding device, in particular can be held rotatably with respect to an axis of rotation oriented transversely and in particular perpendicularly to the processing direction.

For example, portions of the soil surface can first be injected with fluid, in particular compressed air, via the injection elements, thereby loosening the soil, and then the loosened soil portion is driven over by the trailing support device in order to, for example, smooth out elevations in the soil that can be or have been caused by the fluid injection.

It can be provided that the roller-shaped support device forms the at least one, in particular front, support element and/or the at least one, in particular rear, support element or that such a support element is formed by means of the roller-shaped support device.

It can be provided that the fluid supply device comprises a drivable conveying unit for fluid, in particular an air compressor.

It can be provided that the fluid supply device comprises at least one storage container for fluid, which is suppliable with fluid for intermediate storage and which is directly or indirectly in fluid connection with a plurality of injection elements.

It can be provided that the at least one storage container is fixed to the holding device and/or forms part of the holding device.

For example, the at least one storage container can comprise at least one structural element formed as a substantially closed hollow profile or as a pressure vessel or can be in the form of such, which advantageously extends transversely and in particular perpendicularly to the processing direction. This can enable a structurally simple configuration of the storage container. The holding device can be given the required rigidity by means of the at least one storage container. An interior of the at least one storage container can temporarily store the fluid, in particular compressed air, for injection.

It can be provided that the at least one storage container has a round and preferably circular cross section.

The at least one storage container is advantageously made of metal.

It can be provided that the soil treatment apparatus comprises at least one control device for controlling an or the operation, in particular a fluid operation, of the soil treatment apparatus.

It is understood that the lifting device, for example the lifting elements of the lifting device, the at least one braking device and/or the at least one return device can advantageously be controllable by the control device of the soil treatment apparatus.

It can be provided that the at least one travel drive and/or the steering apparatus can advantageously be controllable by the control device of the soil treatment apparatus.

It is understood that the lifting device, for example the lifting elements of the lifting device, the at least one braking device and/or the at least one return device, having corresponding supply conduits for fluid, are in direct or indirect fluid connection with the fluid supply device, for example in indirect fluid connection via the at least one storage container.

It is also understood that the lifting device, for example the lifting elements of the lifting device, the at least one braking device and/or the at least one return device are equipped with corresponding valves for controllable actuation, these valves being advantageously controllable by the control device of the soil treatment apparatus. Preferably, clocked control of the valves is provided in this case.

It should be understood that, although the lifting device, the at least one braking device and/or the at least one return device are described as being fluidly actuatable and/or operable, the lifting device, the at least one braking device and/or the at least one return device can alternatively be configured mechanically and/or electrically.

When implementing the soil treatment apparatus in practice, it proves to be advantageous if the lifting device, the at least one braking device and/or the at least one return device are configured pneumatically. In this way, for example, a or the drivable conveying unit for fluid, in particular a or the air compressor, can be used jointly and additional units and/or apparatuses can be avoided. For example, an in particular separate hydraulic system and/or unit can be dispensed with. However, it should be understood that the lifting device, the at least one braking device and/or the at least one return device can alternatively be configured hydraulically and the soil treatment apparatus can accordingly have a hydraulic motor for providing hydraulic fluid at least for the lifting device, the at least one braking device and/or the at least one return device.

Further preferred features and/or advantages of the present disclosure form the subject matter of the following description and the drawings illustrating exemplary embodiments.

Identical or equally acting features are provided with the same reference numerals in all figures.

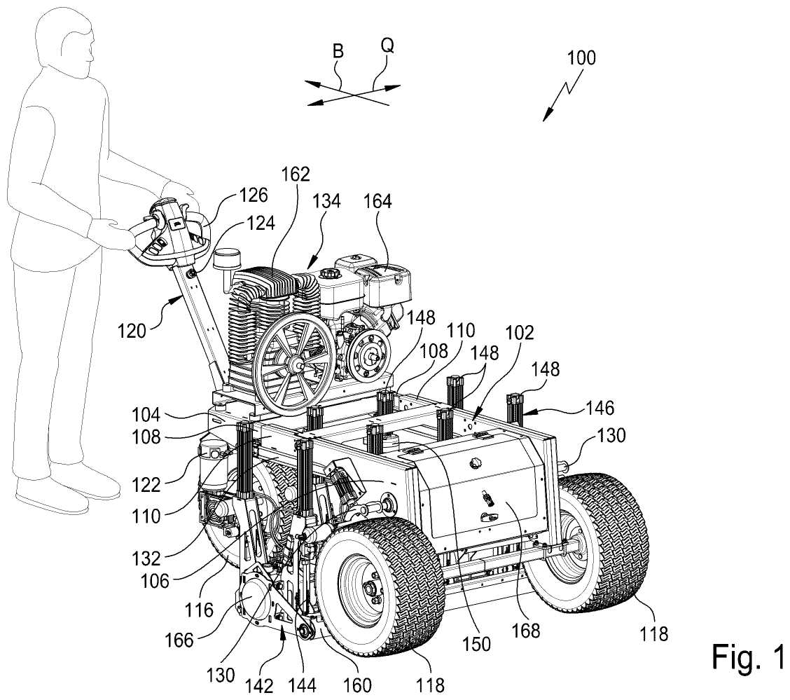

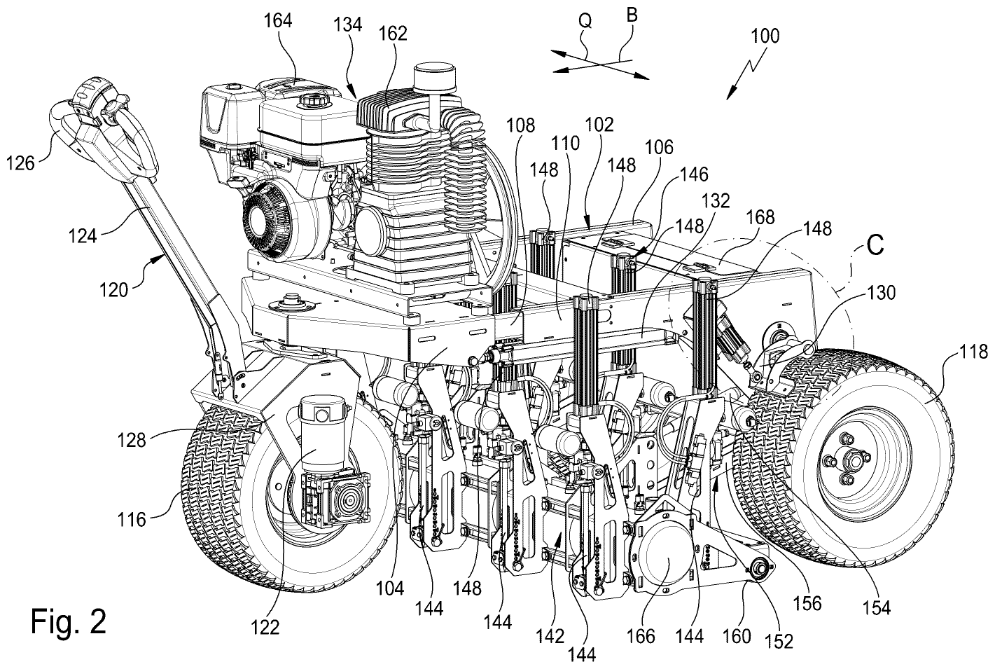

With reference to FIGS. 1 to 9, there is schematically shown a soil treatment apparatus 100 in accordance with an exemplary embodiment of the present disclosure.

The soil treatment apparatus 100 serves in particular for loosening soil, preferably for loosening soil in the case of soils with grass growth.

With the advantageous soil loosening, improved soil aeration, dewatering and drainage can be achieved. This allows the root system of the grass growth to spread better in the soil to promote growth.

It should be understood that the present disclosure is not limited to being applied to soil of the type described; this merely serves to better explain the present disclosure.

The soil treatment apparatus 100 comprises a supporting device 102 which, for example, comprises or is formed as a frame composed of interconnected supports.

The supporting device 102 comprises at least a first supporting device portion 104 and a second supporting device portion 106.

The soil treatment apparatus 100 is configured to be caused to move in a processing direction B via the first supporting device portion 104.

This is to be understood in particular to mean that the soil treatment apparatus 100 is movable on a soil surface, in particular in the processing direction B.

In the processing direction B, the soil treatment apparatus 100 can be moved, for example, in a straight line.

It should be understood that the processing direction B refers to an operationally correct use of the soil treatment apparatus 100. The processing direction B corresponds to a main direction of movement during operationally correct use.

A transverse direction Q of the soil treatment apparatus 100 is oriented transversely and in particular perpendicularly to the processing direction B.

The first and the second supporting device portion 104, 106 are arranged one behind the other in the processing direction B, with the first supporting device portion 104 leading.

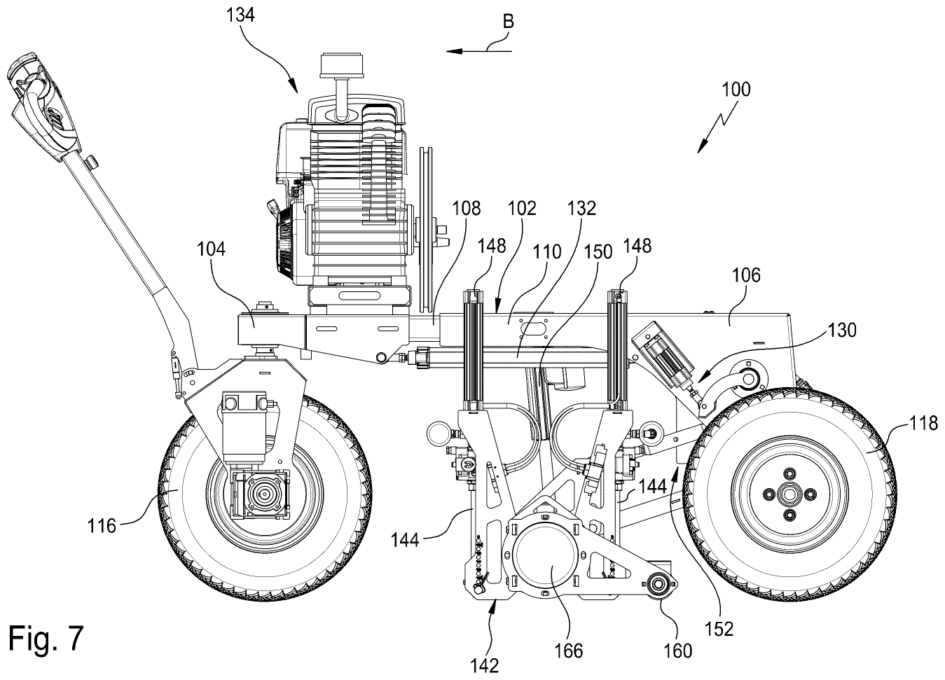

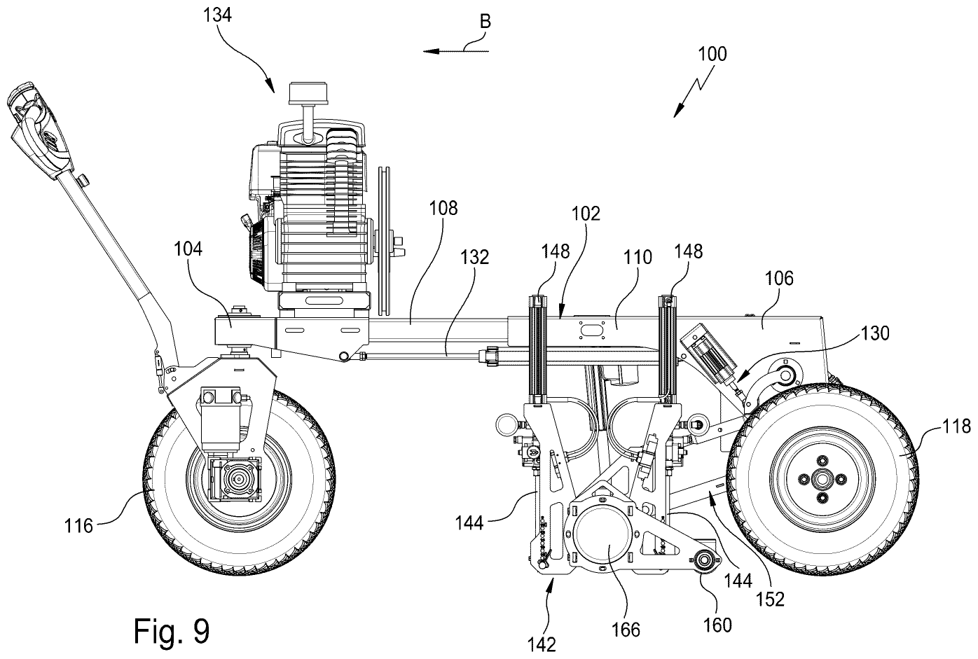

The first and the second supporting device portion 104, 106 are interconnected so as to be movable and in particular displaceable relative to one another in the processing direction B (cf. FIGS. 7 and 9).

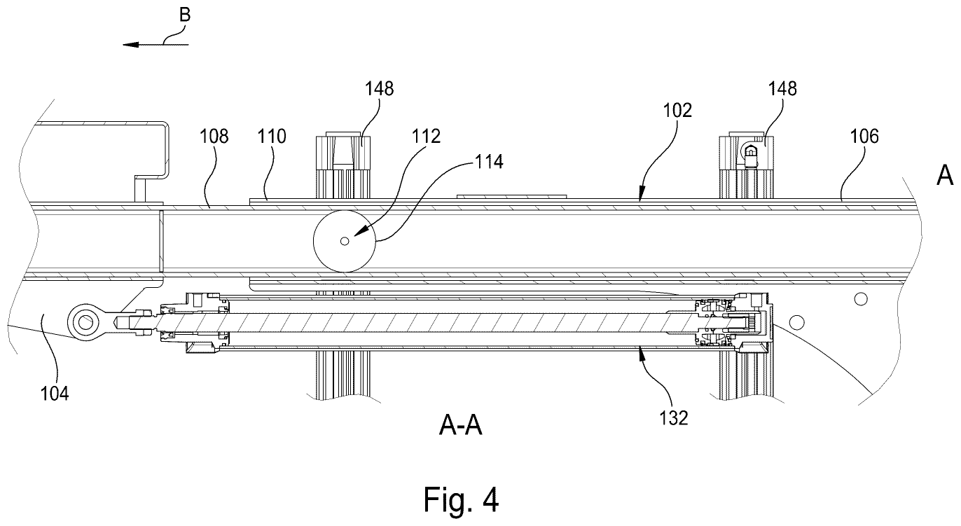

As can be seen in particular in FIG. 4, the first supporting device portion 104 and the second supporting device portion 106 are at least partly mounted in and on one another and are thereby movably and in particular displaceably interconnected.

In particular, the first supporting device portion 104 and the second supporting device portion 106 are interconnected via a corresponding first part and a corresponding second part.

The respective first and the respective second part of the first and second supporting device portion 104, 106 are arranged laterally on opposite sides of the supporting device 102 with respect to the transverse direction Q and are spaced apart from one another.

In a sense, the respective first and the respective second part of the first and second supporting device portion 104, 106 can be regarded as the left-hand part and right-hand part of each of the first and second supporting device portion 104, 106 with respect to a viewing direction from the soil treatment apparatus 100 in the processing direction B.

In particular, the first and the second part of the first supporting device portion 104 are each in the form of a first guide element 108 and the first and the second part of the second supporting device portion 106 are each in the form of a second guide element 110.

Each first guide element 108 and each second guide element 110 extend in the processing direction B.

In the present example, each first guide element 108 has a C-shaped cross section.

In the present example, each second guide element 110 is substantially in the form of a hollow profile which has a substantially rectangular cross section.

Each first guide element 108 is displaceably held in and on the respectively associated second guide element 110.

To a certain extent, the respective first guide element 108 and the respective second guide element 110 are displaceably connected and in particular telescopically interconnected.

The supporting device 102 further comprises at least two bearing arrangements 112, which are provided between the first supporting device portion 104 and the second supporting device portion 106 and in particular between the respective first guide element 108 and the respective second guide element 110.

As can be seen in FIG. 4, the bearing arrangements 112 are each in the form of a roller bearing arrangement.

This realizes a smooth relative movement and in particular relative displacement between the first guide element 108 and the second guide element 110.

Each bearing arrangement 112 comprises, for example, at least one roller 114 which is rotatably mounted in and on the respective second guide element 110.

The respective bearing arrangement 112 and in particular the respective roller 114 are arranged between the respective first guide element 108 and the respective second guide element 110, so that an upper leg of the C-shaped cross section of the first guide element 108 is in engagement by means of the respective bearing arrangement 112 and is in particular guided over the respective roller 114.

The first supporting device portion 104 and the second supporting device portion 106 and in particular the respective first guide element 108 and the respective second guide element 110 are thus movably and in particular displaceably mounted on one another and interconnected, in particular via the respective bearing arrangement 112.

The first supporting device portion 104 and the second supporting device portion 106 are movable and in particular displaceable relative to one another in the processing direction B via the bearing arrangements 112 between a first relative position (cf. FIGS. 1 to 4, 7 and 8) and a second relative position (cf. FIG. 9).

As can be seen in FIGS. 1 to 4, 7 and 8, the supporting device 102 has a shortest extent in the processing direction B in particular when the first supporting device portion 102 and the second supporting device portion 104 are in the first relative position.

In a sense, the soil treatment apparatus 100 is in a pushed-together state when the first supporting device portion 104 and the second supporting device portion 106 are in the first relative position.

Furthermore, as can be seen in FIG. 9, the supporting device 102 has a longest extent in the processing direction B in particular when the first supporting device portion 104 and the second supporting device portion 106 are in the second relative position.

In a sense, the soil treatment apparatus 100 is in a pulled-out state when the first supporting device portion 104 and the second supporting device portion 106 are in the second relative position.

A switching process from the first relative position to the second relative position or from the pushed-together state to the pulled-out state can be understood to mean extending and/or pulling apart.

A switching process from the second relative position to the first relative position or from the pulled-out state to the pushed-together state can be understood to mean shortening and/or contracting.

A support element 116 in the form of a wheel for resting on the soil is provided on the first supporting device portion 104.

In a sense, since the support element 116 in the form of a wheel is provided on the first supporting device portion 104, the support element 116 can be referred to as a front support element 116 and in particular as a front wheel 116.

On the second supporting device portion 106, two further support elements 118, each in the form of a wheel, are provided for resting on the soil, and are spaced apart from one another in the transverse direction Q.

In a sense, since the further support elements 118, each in the form of a wheel, are provided on the second supporting device portion 104, these support elements 118 can be referred to as rear support elements 118 and in particular as rear wheels 118.

The soil treatment apparatus 100 and in particular the supporting device 102 of the soil treatment apparatus 100 is guidable and in particular drivable over the soil via the front wheel 116 and the rear wheels 118.

In the present case, the front wheel 116 is fixed to a front end portion of the first supporting device portion 104 with respect to the processing direction B.

In the present case, the rear wheels 118 are fixed to a rear end portion of the second supporting device portion 106 with respect to the processing direction B.

The supporting device 102 thus extends with respect to the processing direction B substantially between the front wheel 116 and the rear wheels 118.

In particular, the front wheel 116 is arranged substantially centrally with respect to an extent of the first supporting device portion 104 in the transverse direction Q.

In particular, the rear wheels 118 are arranged laterally and on opposite sides with respect to the extent of the second supporting device portion 106 in the transverse direction Q.

The front wheel 116 is steerable and, for example, directly or indirectly drivable and is arranged on the first supporting device portion 104.

For this purpose, the soil treatment apparatus 100 has a steering apparatus 120 and a travel drive 122.

The processing direction B of the soil treatment apparatus 100 can be varied via the steering apparatus 120.

The steering apparatus 120 can be manually actuated by a user.

The steering apparatus 120 comprises a handle device 124, which in this case is lever-shaped, having a handle head 126, which allows the user to operate, in particular to actuate the steering of, the steering apparatus 120, and a suspension device 128 which is rotatably mounted on the first supporting device portion 104 and on which the front wheel 116 is mounted and via which the front wheel 116 is attached to the first supporting device portion 104.

The suspension device 128 is mounted on the first supporting device portion 104 so as to be rotatable about an axis perpendicular to the processing direction B and the transverse direction Q in order to realize steerability of the soil treatment apparatus 100.

The travel drive 122 is in the present case fixed to the suspension device 128 for driving the front wheel 116. The travel drive 122 is in the form of a motor, in particular an electric motor.

The front wheel 116 can be driven by means of the travel drive 122 and in this way the soil treatment apparatus 100 can be caused to move in the processing direction B.

In a sense, the entire soil treatment apparatus 100 can be driven by means of the travel drive 122 via the front wheel 116.

In the present case, the rear wheels 118 are non-steerably and non-drivably attached to the second supporting device portion 106. This could nevertheless be provided for.

The soil treatment apparatus 100 further comprises two braking devices 130, two return devices 132 and a fluid supply device 134.

The braking devices 130 and the return devices 132 are each directly or indirectly in fluid connection with the fluid supply device 134 and are fluidically actuatable and/or operable.

By means of the braking devices, the second supporting device portion 106 is configured to be slowed down and/or braked relative to the first supporting device portion 104 with respect to a movement in the processing direction B when the first supporting device portion 104 is moved in the processing direction B.

This serves in particular to ensure that, when the soil treatment apparatus 100 moves in the processing direction B, the supporting device 102 can be extended in the processing direction B and/or the second supporting device portion 106 can be decelerated and/or stopped with respect to the first supporting device portion 104. In this case, there is in particular the option for the second supporting device portion 104 to be braked until it comes to a standstill relative to the soil, for example temporarily.

This can be understood in particular to mean that by means of the braking devices 130 the supporting device 102 can be caused to extend and/or pull apart when the soil treatment apparatus 100 moves in the processing direction B and in particular when the soil treatment apparatus 100 is caused to move in the processing direction B by means of the travel drive 122.

For example, the first supporting device portion 104 and the second supporting device portion 106 can be transferred from the first relative position to the second relative position and/or the supporting device 102 can be transferred from the pushed-together state to the pulled-out state by means of the braking devices 130.

The respective braking devices 130 are arranged laterally on opposite sides of the supporting device 102 with respect to the transverse direction Q.

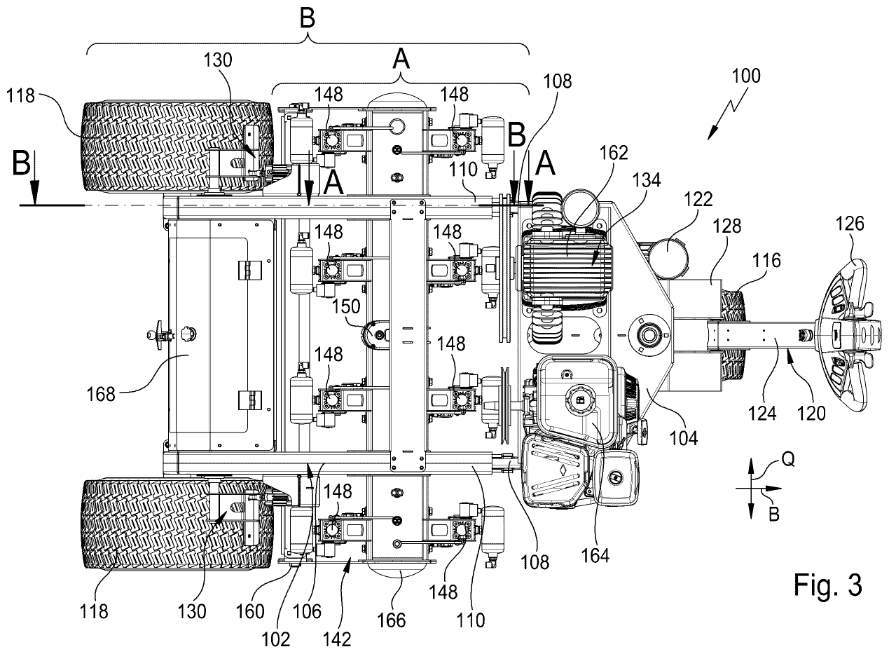

In particular, the respective braking devices 130 are arranged so as to correspond to the rear wheels 118, as can be seen in particular in FIG. 3.

Each rear wheel 118 is associated with a respective braking device 130.

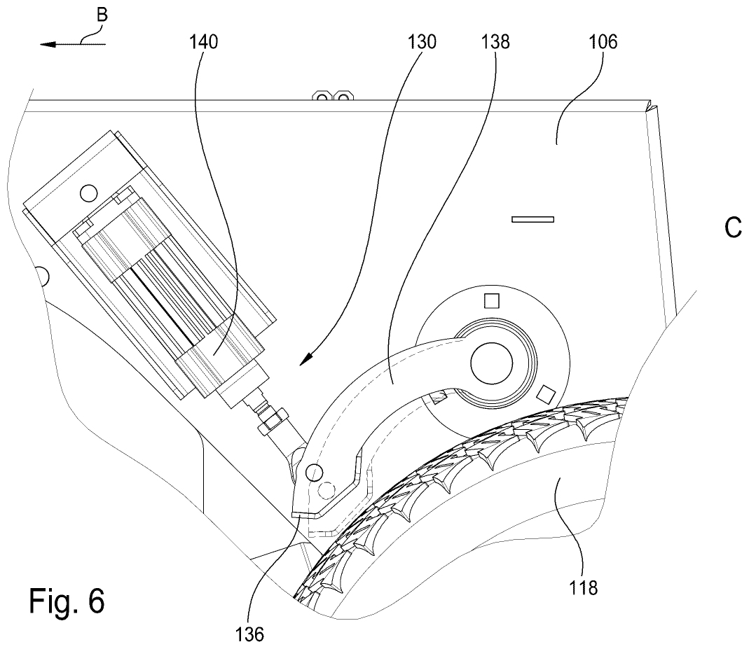

Each braking device 130 can be brought into engagement with the respectively associated rear wheel 118 in order to slow down and/or brake the second supporting device portion 106 (cf. FIG. 6).

In particular, by means of the braking devices 130, the second supporting device portion 106 can be slowed down and/or braked relative to the first supporting device portion 104 in a frictionally engaged manner.

As can be seen in particular in detail in FIG. 6, each braking device 130 comprises a braking element 138, which is provided with a brake pad 136, and a fluidically actuatable actuator 140.

The respective actuator 140 is fixed to the second supporting device portion 106.

The respective braking element 138 is in the form of a lever arm member and is pivotably attached at one end to the second supporting device portion 106 and, for example at the other end, is connected to the respective actuator 140. The respective brake pad 136 is also attached at this other end.

The respective brake pad 136 can be pressed against the relevant rear wheel 118 by a movement of the respective braking element 138 which can be brought about by means of the respective actuator 140; this is shown schematically in particular in FIG. 6.

As can be seen in FIG. 6, each braking device 130 is transferable by means of the respective actuator 140 from a non-braking position (cf. dashed contour) to a braking position (cf. non-dashed contour) and/or vice versa.

In the braking position, the braking element 138 rests in particular flatly against an outer circumference of the wheel 118 and in particular thereon.

By means of the return devices 132, the first supporting device portion 104 and the second supporting device portion 106 are movable relative to one another and in particular toward one another.

This serves in particular to ensure that, when the soil treatment apparatus 100 moves in the processing direction B, the supporting device 102 can be shortened again in the processing direction B after being extended, in particular can be returned to an initial state, for example to the first relative position and/or the pushed-together state.

The respective return devices 132 are arranged laterally on opposite sides of the supporting device 102 with respect to the transverse direction Q.

Each return device 132 is fixed to the first supporting device portion 104 and the second supporting device portion 106 and interconnects the first supporting device portion 104 and the second supporting device portion 106.

In particular, the return devices 132 are arranged so as to correspond to the first and second guide elements 108, 110.

Each return device 132 is in the present case in the form of a fluidically actuatable lifting cylinder. By means of the return devices 132, the supporting device 102 can be caused to shorten and/or contract and/or the shortening and/or contraction of the supporting device 102 can be brought about while the soil treatment apparatus 100 moves in the processing direction B and in particular while the soil treatment apparatus 100 is caused to move in the processing direction B by means of the travel drive 122.

For example, the first supporting device portion 104 and the second supporting device portion 106 can be transferred from the second relative position to the first relative position and/or the supporting device 102 can be transferred from the pulled-out state to the pushed-together state by means of the return devices 132.

The braking devices 130 are in particular released and/or unactuated during shortening and/or contraction.

In the present case, the return devices 132 and the braking devices 130 are operatively interconnected and, in particular, are fluidically interconnected.

Actuation of the return devices 132 for shortening and/or contracting the supporting device 102 is coupled with release and/or non-actuation of the braking devices 130.

In particular, applying pressure to the return devices 132 is coupled with switching the braking devices 130 and in particular their actuators 140 to a pressureless state.

Actuation of the return devices 132 for extending and/or pulling apart the supporting device 102 is coupled with engagement and/or actuation of the braking devices 130.

In particular, switching the return device 132 to a pressureless state is coupled with applying pressure to the braking devices 130 and in particular to their actuators 140.

Furthermore, the soil treatment apparatus 100 comprises a holding device 142, a plurality of injection elements 144 and a lifting device 146.

The injection elements 144 serve in particular to inject a or the fluid, respectively, into the soil. Under the effect of the fluid, in particular a compressed gas or compressed gas mixture, especially compressed air, loosening and thus better ventilation and dewatering of the soil can be realized.

The holding device 142 is held on the supporting device 102 in particular movably.

In particular, the holding device 142 is held on the second supporting device portion 106.

The injection elements 144 are held on the holding device 142.

The injection elements 144 can be inserted into and withdrawn from the soil via a lifting device 146.

The fluid supply device 134 is in fluid connection with the injection elements 144 for providing fluid directly or indirectly.

In particular, the injection elements 144 are insertable into and withdrawable from the soil by means of the lifting device 146 during a relative movement and in particular a relative displacement of the first supporting device portion 104 and the second supporting device portion 106 to one another or when the soil treatment apparatus 100 is not caused to move.

This can ensure, for example, that damage to the injection elements 144 when inserted into the soil, when being inserted and/or when being withdrawn, for example due to a shear force caused by movement, can be reliably avoided.

The injection elements 144 are movably held on the holding device 142.

In particular, the injection elements 144 are held on the holding device 142 so as to be movable in a direction relative to the processing direction B and the transverse direction, for example vertically.

The lifting device 146 comprises a number of lifting elements 148 corresponding to the injection elements 144 held so as to be movable relative to the holding device 142.

The respective injection elements 144 can be inserted into and withdrawn from the soil via the lifting elements 148.

In particular, each injection element 144 is associated with a lifting element 148 on which the injection element 144 is movably held.

The associated injection element 144 can be inserted into and withdrawn from the soil via the respective lifting element 148.

In a sense, the respective injection elements 144 can be singly and/or individually inserted into and withdrawn from the soil via the lifting elements 148.

For this purpose, the respective lifting elements 148 are operatively connected to the respective injection elements 144 for insertion into and withdrawal from the soil.

The lifting elements 148 are fixed to the holding device 142.

Each lifting element 148 of the lifting device 146 is in direct or indirect fluid connection with the fluid supply device 134.

The injection elements 144 are insertable into and withdrawable from the soil by means of the lifting device 146, in particular by means of the lifting elements 148 of the lifting device 146 during the extension and/or pulling apart.

The lifting device 146, in particular the lifting elements 148, can be configured, for example, in the same way as described in the not previously published patent application DE 10 2023 100 886.2 of the same applicant with the same filing date as the present patent application.

When the injection elements 144 are inserted into the soil, the fluid can be supplied to the soil via the injection elements 144, in particular can be injected, in particular for loosening the soil.

After and in particular after each extension and/or pulling apart of the supporting device 102, a or the shortening and/or contraction of the supporting device 102 can be initiated by means of the return devices 132.

During a driving operation of the soil treatment apparatus 100, deceleration between the first and the second supporting device portion 104, 106 can therefore be carried out due to the relative mobility of the first and the second supporting device portion 104, 106 to one another, so that the injection elements 144 arranged on the second supporting device portion 106 can be inserted into and withdrawn from the soil during the driving operation.

In particular, since by means of the braking devices 130 the second supporting device portion 106 can be slowed down and/or braked relative to the first supporting device portion 104 with respect to the movement in the processing direction B, the supporting device 102 can be extended in the processing direction B, with the result that the injection elements 144 can be inserted into and withdrawn from the soil during ongoing driving operation of the soil treatment apparatus 100, preferably without any damage to the injection elements 144 occurring.

Furthermore, since the first supporting device portion 104 and the second supporting device portion 106 are movable relative to one another and in particular toward one another by means of the return devices 132, the supporting device 102 can be repeatedly returned to its initial state, so that, for example, quasi-continuous or continuous operation of the soil treatment apparatus 100 can be realized.

In a sense, the first and the second supporting device portion 104, 106 can be moved apart from and toward one another as required and the injection elements 144 are insertable into the soil and withdrawable from the soil in a correspondingly synchronized manner.

The soil treatment apparatus 100 further comprises an adjustment device 150 by means of which the holding device 142 can be lifted and lowered relative to the soil.

The adjustment device 150 is, for example, in the form of an electric linear actuator, which can be optionally shortened or extended upon actuation.

The adjustment device 150 serves in particular for finely adjusting a distance between the holding device 142 and the soil.

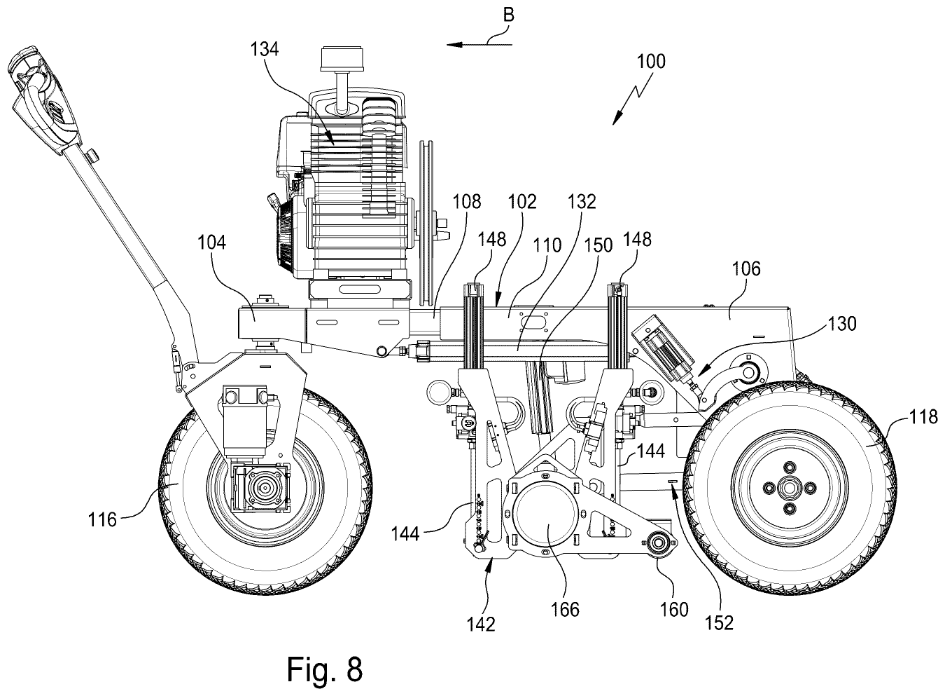

Furthermore, the adjustment device 150 serves to realize a soil treatment position of the holding device 142, in which the holding device 142 is lowered (cf. FIGS. 7 and 9), and a transport position of the holding device 142, in which the holding device 142 is lifted (cf. FIG. 8).

It should be understood that the holding device 142 is preferably situated in the soil treatment position during the operationally correct insertion and withdrawal of the injection elements 144.

The adjustment device 150 is mounted on the inside of and in particular centrally on the second supporting device portion 106 and the holding device 142 with respect to an extent of the second supporting device portion 106 and the holding device 142 oriented transversely and in particular perpendicularly to the processing direction B and interconnects the second supporting device portion 106 and the holding device 142.

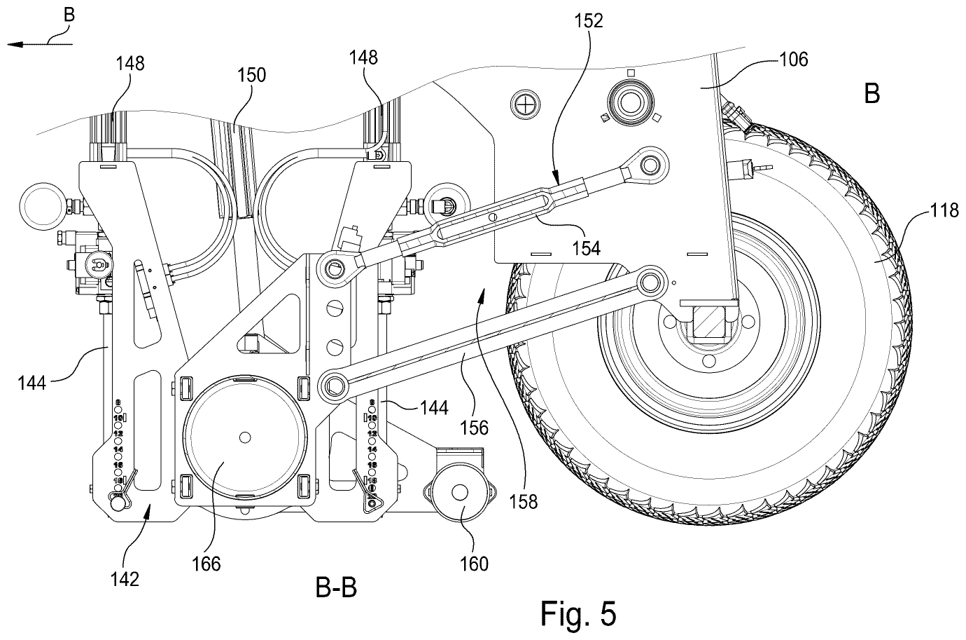

By means of a guide apparatus 152, the holding device 142 is movably held on the supporting device 102 and in particular the second supporting device portion 106 (cf. FIG. 5). Via this guide apparatus 152, the holding device 142 can be lifted and lowered in a guided manner by means of the adjustment device 150.

In particular, the guide apparatus 152 is in the form of a joint apparatus and comprises two first guide members 154 and two second guide members 156.

The guide members 154, 156 are respectively mounted on the holding device 142 and on the supporting device 102 and in particular on the second supporting device portion 106 and are arranged spaced apart from one another and substantially parallel to one another.

A parallelogram linkage 158 for lifting and lowering the holding device 142 is realized by means of a first guide member 154 and a second guide member 156, as can be seen in particular in FIG. 5.

This creates a robust structure for the guided lifting and lowering of the holding device 142.

Furthermore, a roller-shaped support device 160 is movably held on the holding device 142.

The roller-shaped support device 160 is arranged downstream of the injection elements 144 with respect to the processing direction B.

The roller-shaped support device 160 extends transversely and in particular perpendicularly to the processing direction B.

In particular, the roller-shaped support device 160 is held rotatably on the holding device 142 with respect to a rotational axis oriented transversely and in particular perpendicularly to the processing direction B.

For example, portions of the soil surface can be injected with fluid, in particular compressed air, via the injection elements 144, thereby loosening the soil. The loosened soil portion is then driven over by the trailing support device 160 in order to, for example, smooth out elevations in the soil that can be or have been caused by the fluid injection.

As can be seen in particular in FIGS. 1 to 3, the fluid supply device 134 comprises a drivable conveying unit for fluid, in particular an air compressor 162, and an internal combustion engine 164, the air compressor 162 being drivable by means of the internal combustion engine 164 and being driven during operation. Instead of the internal combustion engine 164, a different type of engine could be used.

It should be understood that a torque transmission element between the air compressor 162 and the internal combustion engine 164 has been omitted to improve the clarity of the figures. The torque transmission element can be in the form of a belt or a chain, for example.

The fluid supply device 134 further comprises a storage container 166 for fluid, which is suppliable with fluid for intermediate storage and which is directly or indirectly in fluid connection with the injection elements 144.

The storage container 166 is fixed to the holding device 142 and forms part of the holding device 142.

The storage container 166 extends transversely and in particular perpendicularly to the processing direction B. The holding device 142 can be given the required rigidity by means of the storage container 166.

The storage container 166 can temporarily store the fluid, in particular compressed air, for injection.

The storage container 166 has a round and preferably circular cross section. The storage container 166 is advantageously made of metal.

Furthermore, the soil treatment apparatus 100 has a control device 168 for controlling an or the operation, in particular a fluid operation, of the soil treatment apparatus 100.

In the present case, the control device 168 is housed in the end portion of the second supporting device portion 106, thus ensuring that it is safely stored and protected from external influences.

In addition, an energy storage, e.g., an in particular rechargeable battery, can be accommodated in said end portion and can be used to supply the adjustment device 150 and the travel drive 122 with energy.

It is understood that the lifting device 146, in particular the lifting elements 148 of the lifting device 146, the braking devices 130 and the return devices 132 can be controlled by the control device 168 of the soil treatment apparatus 100.

Furthermore, the adjustment device 150 and the travel drive 122 can be controllable via the control device 168.

It is further understood that the lifting device 146, in particular the lifting elements 148 of the lifting device 146, the braking devices 130 and the return devices 132, having corresponding fluid supply conduits, are in direct or indirect fluid connection with the fluid supply device 134, for example in indirect fluid connection via the storage container 166.

It is also understood that the lifting device 146, in particular the lifting elements 148 of the lifting device 146, the braking devices 130 and the return devices 132 are equipped with corresponding valves for controllable actuation and these valves can be controlled by the control device 168 of the soil treatment apparatus 100.

Referring in particular to FIGS. 7 to 9, the operation of the soil treatment apparatus 100 is again described coherently.

The soil treatment apparatus 100 is manually steered by a user to a destination via the steering apparatus 120, the soil treatment apparatus 100 being driven by the travel drive 122.

In this case, the holding device 142 is situated in the transport position (cf. FIG. 8).

At the destination, the holding device 142 is lowered into the soil treatment position by means of the adjustment device 150 (cf. FIG. 7).

The soil treatment apparatus 100 is then driven and steered by the user over the soil to be treated.

The supporting device 102 is first in the retracted state, or the first relative position is present (cf. FIG. 7).

The rear wheels 118 are now braked by means of the braking devices 130 (cf. FIG. 9), so that the second supporting device portion 106 remains stationary, while the first supporting device portion 104 continues to move.

In this case the supporting device 102 is extended and the injection elements 144 are inserted into the soil by means of the lifting elements 148 and fluid, in particular the compressed gas or compressed gas mixture, for example air, is injected into the soil to loosen the soil.

The injection elements 144 are then withdrawn back out of the soil by means of the lifting elements 148. The supporting device 102 is now in the pulled-out state, or the second relative position is present (cf. FIG. 9).

The braking devices 130 are released and the second supporting device portion 106 is moved again in the direction of the first supporting device portion 104 by means of the return devices 132.

It should be understood that during these processes the soil treatment apparatus 100 and in particular the first supporting device portion 104 continue to be moved.

When the second supporting device portion 106 and the first supporting device portion 104 are back in their starting position, in particular the first relative position or in the pushed-together state (cf. FIG. 7), the rear wheels 118 are braked again to extend the supporting device 102 and the sequence restarts from the beginning.

This makes it possible to realize quasi-continuous or continuous operation of the soil treatment apparatus 100.

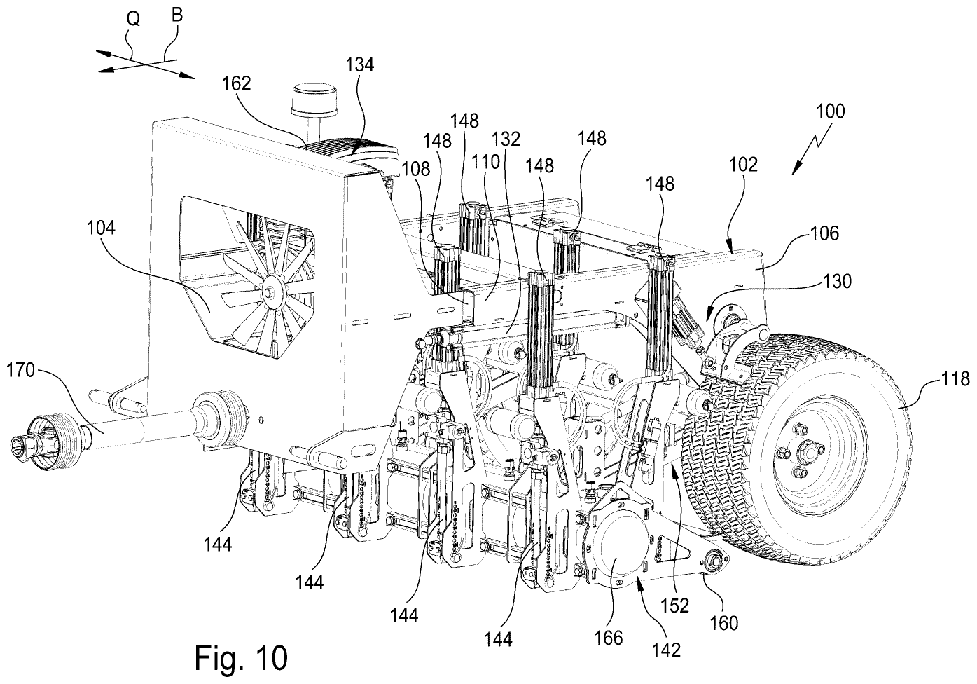

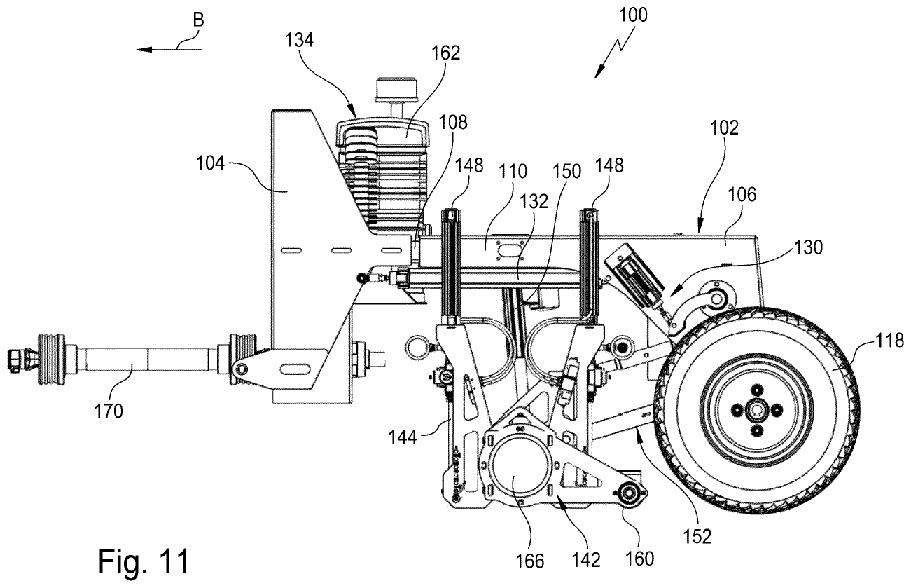

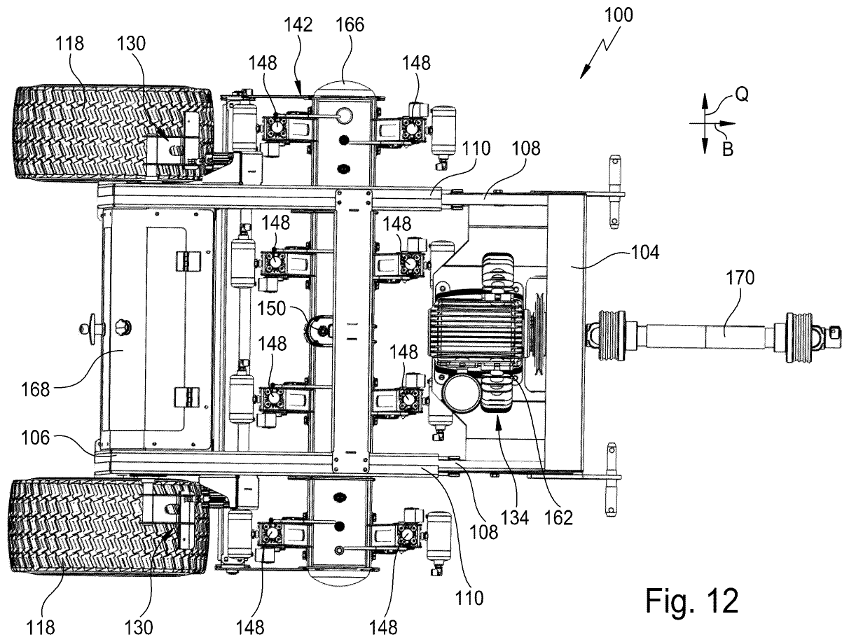

With reference to FIGS. 10 to 12, there is schematically shown a soil treatment apparatus 100 in accordance with a further exemplary embodiment of the present disclosure.

The soil treatment apparatus 100 of FIGS. 10 to 12 is substantially configured and/or designed like the soil treatment apparatus 100 of FIGS. 1 to 9, and therefore the differences in particular are described below.

In particular, the soil treatment apparatus 100 of FIGS. 10 to 12 does not comprise a front wheel 116 or an internal combustion engine 164.

However, the soil treatment apparatus 100 of FIGS. 10 to 12 comprises a coupling device 170.

The coupling device 170 is arranged on and fixed to the first supporting device portion 104 for coupling the soil treatment apparatus 100 to a separate drive system, in particular a towing vehicle, for example a tractor.

Via the coupling device 170, the soil treatment apparatus 100 is configured to be caused to move in the processing direction B, in particular by means of a tensile force able to be exerted by the separate drive system.

In a sense, the soil treatment apparatus 100 is pulled by the separate drive system.

Via the coupling device 170, the soil treatment apparatus 100 can be steered and in particular the processing direction B can be varied.

In a sense, the steering apparatus 120 is realized by the coupling device 170 and can be actuated by the separate drive system by means of a pulling movement able to be generated thereby.

Furthermore, a torque can be transmitted via the coupling device 170 to the soil treatment apparatus 100 and in particular to the air compressor 162 so that it can be operated by the separate drive system.

The operating principle or operation of the soil treatment apparatus 100 of FIGS. 10 to 12 is analogous to the operating principle or operation of the soil treatment apparatus 100 of FIGS. 1 to 9.

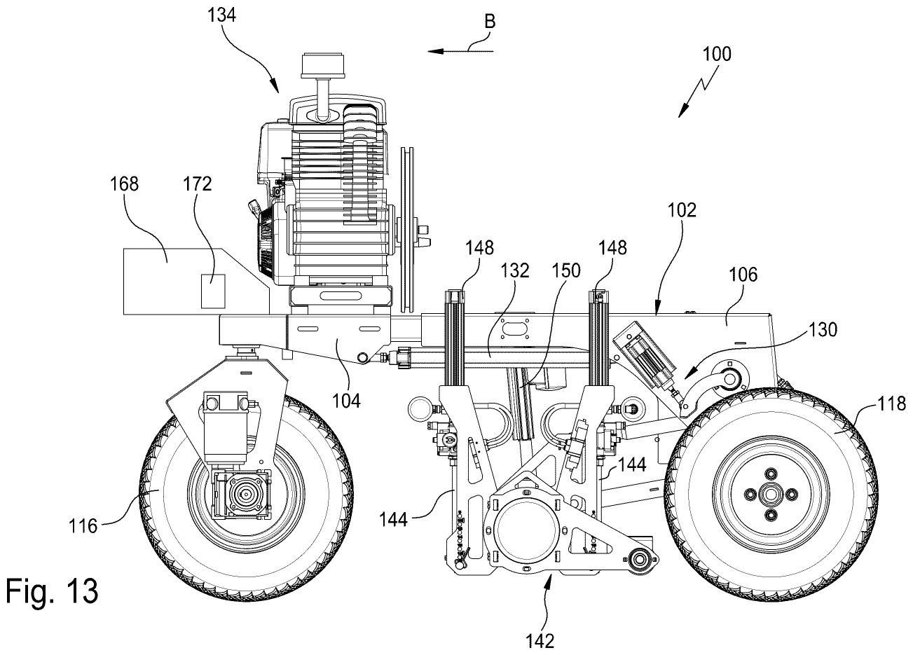

With reference to FIG. 13, there is schematically shown a soil treatment apparatus 100 in accordance with a further exemplary embodiment of the present disclosure.

The soil treatment apparatus 100 of FIG. 13 is substantially configured and/or designed like the soil treatment apparatus 100 of FIGS. 1 to 9, and therefore the differences in particular are described below.

The soil treatment apparatus 100 of FIG. 13 comprises a control unit 168, by means of which the soil treatment apparatus 100 is automatically actuatable and in particular controllable, preferably self-drivingly and/or self-steeringly controllable.

The steering apparatus 120 here comprises a motor 172, in particular an electric motor, via which the processing direction B can be varied and which can be controlled by means of the control unit 168.

The travel drive 122 can also be controlled by means of the control unit 168.

The control unit 168 further comprises a device for navigation, for example comprising a GPS unit, an optical navigation unit (lidar, camera, etc.), and/or a detection unit for detecting a soil contour.

It can be provided that the control unit 168 is or comprises a computer system and/or is or can be connected to a computer system. It can be provided that the computer system can be a server, in particular a cloud-based server.

It can be provided that the control unit 168 is configured to detect and/or provide at least one piece of information about the soil, for example via sensor units connected to the control unit 168, e.g., a camera unit and/or a detection unit.

In particular, the information can be provided to one or more information recipients and an information recipient can be, for example, a user, in particular an end user, e.g., a gardener, groundskeeper, and/or greenkeeper, a display unit, a mobile terminal, software, in particular an app, a server, a computer, a cloud, etc.

As a result, an autonomous operation of the soil treatment apparatus 100 can be realized.

The operating principle or operation of the soil treatment apparatus 100 of FIG. 13 is otherwise analogous to the operating principle or operation of the soil treatment apparatus 100 of FIGS. 1 to 9.

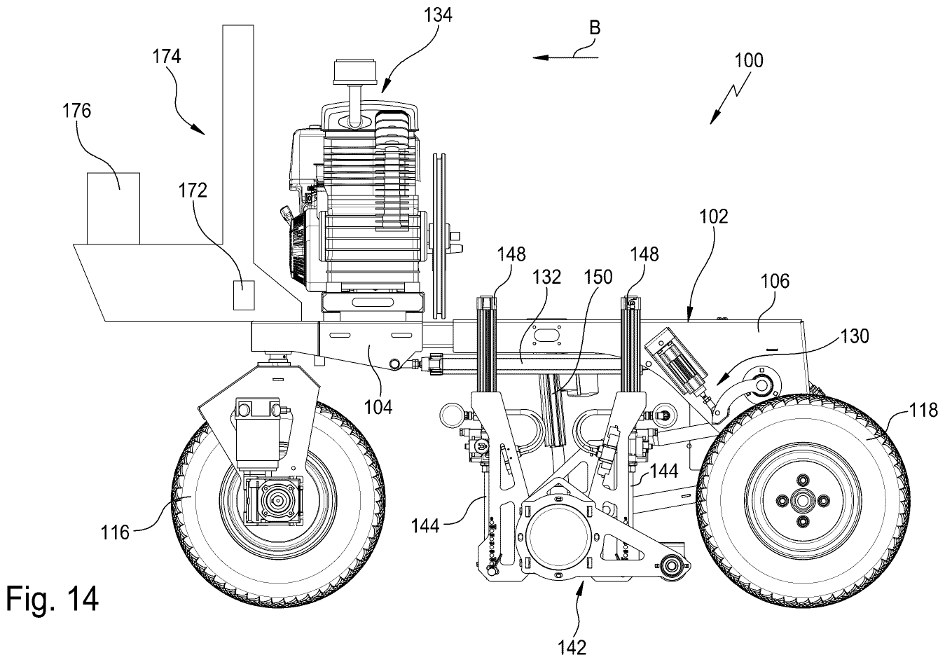

With reference to FIG. 14, there is schematically shown a soil treatment apparatus 100 in accordance with a further exemplary embodiment of the present disclosure.

The soil treatment apparatus 100 of FIG. 14 is substantially configured and/or designed like the soil treatment apparatus 100 of FIGS. 1 to 9, so that the differences in particular are described below. The soil treatment apparatus 100 of FIG. 14 comprises a seat unit 174 for a user to sit on.

An operating unit 176 for operating and controlling, in particular steering, the soil treatment apparatus 100 is provided on the seat unit 174.

For this purpose, the steering apparatus 120 comprises in particular a motor 172, in particular an electric motor, via which the processing direction B can be varied and which can be controlled by means of the control unit 168 in accordance with a user input via the operating unit 176.

In the present case, the motor 172 is integrated in the seat unit 174.

Optionally, the control unit 168 can further comprise a device for navigation, for example comprising a GPS unit, an optical navigation unit (lidar, camera, etc.), and/or a detection unit for detecting a soil contour, with the result that autonomous operation of the soil treatment apparatus 100 can additionally be realized. For example, it may be conceivable for the soil treatment apparatus 100 to be driven to its destination by a user, at which destination the soil treatment apparatus 100 autonomously treats the soil, in particular ventilates the soil.

The operating principle or operation of the soil treatment apparatus 100 of FIG. 14 is otherwise analogous to the operating principle or operation of the soil treatment apparatus 100 of FIGS. 1 to 9.

### LIST OF REFERENCE NUMERALS

100 Soil treatment apparatus
102 Supporting device
104 First supporting device portion
106 Second supporting device portion
108 First guide element
110 Second guide element
112 Bearing arrangement
114 Roller
116 Front support element, front wheel
118 Rear support element, rear wheel
120 Steering apparatus
122 Travel drive
124 Handle device
126 Handle head
128 Suspension device
130 Braking device
132 Return device
134 Fluid supply device
136 Brake pad
138 Braking element
140 Actuator
142 Holding device
144 Injection element
146 Lifting device
148 Lifting element
150 Adjustment device
152 Guide apparatus
154 First guide member
156 Second guide member
158 Parallelogram linkage
160 Support device
162 Air compressor
164 Internal combustion engine
166 Storage container
168 Control device, control unit
170 Coupling device
172 Motor of steering apparatus
174 Seat unit
176 Operating unit
B Processing direction
Q Transverse direction

1. A soil treatment apparatus for loosening soil, the soil treatment apparatus comprising:
a supporting device;
a holding device movably held on the supporting device, on which a plurality of injection elements are held;
a lifting device; and
a fluid supply device which is directly or indirectly in fluid connection with the injection elements for providing fluid,
the injection elements being insertable into and withdrawable from the soil via the lifting device,
the supporting device comprising at least a first supporting device portion and a second supporting device portion,
the soil treatment apparatus being configured to be caused to move in a processing direction via the first supporting device portion and the holding device is held on the second supporting device portion,
the first supporting device portion and the second supporting device portion being arranged one behind the other in the processing direction and being interconnected so as to be displaceable relative to one another in the processing direction.

2. The soil treatment apparatus in accordance with claim 1, wherein the injection elements are insertable into and withdrawable from the soil by the lifting device during a displacement of the first supporting device portion and the second supporting device portion relative to one another or when the soil treatment apparatus is not caused to move.

3. The soil treatment apparatus in accordance with claim 1, wherein the first supporting device portion and the second supporting device portion are at least partly mounted in and/or on one another in order to be displaceably interconnected.

4. The soil treatment apparatus in accordance with claim 1, wherein:
at least one part of the first supporting device portion or the second supporting device portion is a first guide element and at least one part of the respective other supporting device portion is a second guide element, and the first guide element and the second guide element are displaceably connected and telescopically interconnected.

5. The soil treatment apparatus in accordance with claim 1, wherein:
the first supporting device portion and the second supporting device portion are displaceable between a first relative position and a second relative position relative to one another in the processing direction,
the supporting device has a shortest extent in the processing direction when the first supporting device portion and the second supporting device portion are in the first relative position,
the supporting device has a longest extent in the processing direction when the first supporting device portion and the second supporting device portion are in the second relative position.

6. The soil treatment apparatus in accordance with claim 1, wherein:
the soil treatment apparatus comprises at least one braking device, and
the second supporting device portion is configured to be slowed down and/or braked relative to the first supporting device portion by the at least one braking device, with respect to a movement in the processing direction.

7. The soil treatment apparatus in accordance with claim 6, wherein:
the second supporting device portion comprises at least one support element for resting on the soil,
the supporting device of the soil treatment apparatus is guidable and/or drivable over the soil via the at least one support element, and
the at least one braking device is configured to be brought into engagement with the at least one support element and/or directly with the soil.

8. The soil treatment apparatus in accordance with claim 7, wherein the at least one support element is a wheel or a roller.

9. The soil treatment apparatus in accordance with claim 6, wherein the at least one braking device is directly or indirectly in fluid connection with the fluid supply device and is fluidically actuatable for slowing down and/or braking the second supporting device portion.

10. The soil treatment apparatus in accordance with claim 6, wherein the second supporting device portion is configured to be slowed down relative to the first supporting device portion via a frictional connection and/or braked via a frictional connection and/or via a positive engagement by the at least one braking device.

11. The soil treatment apparatus in accordance with claim 6, wherein:
at least one support element comprising a wheel or a roller is provided on the second supporting device portion,
the at least one braking device comprises a braking element provided with a brake pad and a fluidically actuatable actuator, and
the brake pad is pressable against the at least one support element by a movement of the braking element able to be brought about by the actuator.

12. The soil treatment apparatus in accordance with claim 1, further comprising at least one return device that is fixed to the first supporting device portion and the second supporting device portion, the at least one return device interconnecting the first supporting device portion and the second supporting device portion, the first supporting device portion and the second supporting device portion being movable toward one another by the at least one return device.

13. The soil treatment apparatus in accordance with claim 12, wherein the at least one return device is directly or indirectly in fluid connection with the fluid supply device.

14. The soil treatment apparatus in accordance with claim 1, further comprising at least one guide apparatus, wherein:
the holding device is movably held on the supporting device by the at least one guide apparatus,
the holding device is liftable and lowerable by the at least one guide apparatus, and
the at least one guide apparatus comprises or forms at least one joint apparatus or comprises or forms at least one linear guide apparatus for translational guidance.

15. The soil treatment apparatus in accordance with claim 14, wherein:
the at least one guide apparatus comprises at least a first guide member and a second guide member,
the first guide member and the second guide member each mounted on the holding device and on the supporting device, and
the first guide member and the second guide member being arranged spaced apart from one another and substantially parallel to one another.

16. The soil treatment apparatus in accordance with claim 15, wherein the first guide member and the second guide member form a parallelogram linkage for lifting and lowering the holding device.

17. The soil treatment apparatus in accordance with claim 1, further comprising one or more injection elements held on the holding device so as to be movable relative to the holding device, wherein:
the lifting device comprises at least a number of lifting elements corresponding to the injection elements held so as to be movable relative to the holding device,
the respective injection elements are insertable into and withdrawable from the soil via the number of lifting elements, and
the number of lifting elements are directly or indirectly in fluid connection with the fluid supply device.

18. The soil treatment apparatus in accordance with claim 1, wherein:
the soil treatment apparatus has at least one travel drive arranged on and/or in the first supporting device portion, and
the soil treatment apparatus is configured to be caused to move in the processing direction by the at least one travel drive.

19. The soil treatment apparatus in accordance with claim 1, wherein:
the soil treatment apparatus has at least one coupling device arranged on and/or in the first supporting device portion for coupling the soil treatment apparatus to a separate drive system, and
the soil treatment apparatus is configured to be caused to move in the processing direction via the at least one coupling device by a tensile force able to be exerted by the separate drive system.

20. The soil treatment apparatus in accordance with claim 1, wherein:
the soil treatment apparatus has a steering apparatus,
the processing direction is variable via the steering apparatus, and
one the following applies:
the steering apparatus is manually actuatable by a user;
the steering apparatus is actuatable by a separate drive system for the soil treatment apparatus generating a pulling movement;
the steering apparatus is controllable automatically by a control unit associated with the soil treatment apparatus or comprised by the soil treatment apparatus.

21. The soil treatment apparatus in accordance with claim 1, wherein:
the fluid supply device comprises a drivable conveying unit for fluid;
the fluid supply device further comprises at least one storage container for fluid,
the at least one storage container is suppliable with fluid for intermediate storage, and
the at least one storage container is directly or indirectly in fluid connection with a plurality of injection elements.
